(19) United States
(12) Patent Application Publication
(10) Pub. No.: US 2012/0264392 A1
(43) Pub. Date: Oct. 18, 2012

(54) EAR PIECE COMMUNICATION DEVICE

(76) Inventor: Tabassom Ayazi, Torrance, CA (US)

(21) Appl. No.: 13/087,686

(22) Filed: Apr. 15, 2011

(51) Int. Cl. H04B 1/08

(52) U.S. Cl. 455/350

(57) ABSTRACT

A communication device includes a body having a first portion configured to fit at least partly inside a portion of a user's ear canal, and a second portion connected to the first portion and configured to be positioned at least partly within an outer ear of the user. The communication device further includes a radio assembly at least partly housed in the body. The radio assembly includes a receiver configured to receive radio signals, a battery configured to power the receiver, and a speaker connected to the radio and configured to provide audio signals to the user through the first portion. The second portion may include an external surface area outwardly facing relative to the outer ear of the user. The external surface area is configured to display visual information.

### FIELD

The present application generally relates to personal communication devices, and more particularly, to an earpiece communication device.

### BACKGROUND

Portable radios are used for listening to music, sporting events, live programs, talk shows, etc. Some portable radios are wearable on a user's ears, such as headphone radios. These radios typically have removable or rechargeable batteries and can be tuned to the frequencies of the broadcast FM and/or AM bands. However, even these radios may be bulky, heavy and uncomfortable to wear. Other radios may have a portable unit with a separate in ear headphones that can be plugged into a jack on the portable unit. These radios also typically have removable or rechargeable batteries and can be tuned to the frequencies of the broadcast FM and/or AM bands. However, these radios require the user to carry the portable unit by either holding the unit or carrying it in his or her pocket. Additionally, the user must carry in the ear type or other types of headphones separately for use with the portable unit.

### SUMMARY

According to one embodiment, a communication device includes a body having a first portion configured to fit at least partly inside a portion of a user's ear canal, and a second portion connected to the first portion and configured to be positioned at least partly within an outer ear of the user. The communication device further includes a radio assembly at least partly housed in the body. The radio assembly includes a receiver configured to receive radio signals, a battery configured to power the receiver, and a speaker connected to the radio and configured to provide audio signals to the user through the first portion.

According to another embodiment, the second portion includes an external surface area outwardly facing relative to the outer ear of the user. The external surface area is configured to display visual information.

According to another embodiment, a section of the second portion which includes the external surface area is removable from the second portion.

According to another embodiment, a largest dimension of the external surface area is at least 1 inch.

According to another embodiment, a largest dimension of the external surface area is at least between 1 inch and 2 inches.

According to another embodiment, the visual information is provided on a sheet-like material which is attached to the external surface area.

According to another embodiment, the battery is configured to power the radio receiver for less than 5 hours.

According to another embodiment, the battery is a rechargeable battery.

According to another embodiment, the battery is removable from the body and replaceable with another battery.

According to another embodiment, the communication device includes a volume control and an ON/OFF switch mounted on the body and operatively coupled to the radio receiver.

According to another embodiment, the first portion is removable from the body.

According to another embodiment, the communication device includes a plurality of first portions configured to be interchangeably connectable to the body.

According to another embodiment, the first portion is at least partly constructed from an elastically pliable material such that the first portion is configured to be shaped by a user to fit in the user's ear canal.

### BRIEF DESCRIPTION OF THE DRAWINGS

FIG. 1 shows a side cross-sectional view of a portion of a human ear having an ear piece communication device inserted therein according to an exemplary embodiment.

FIG. 2 shows a front view of a portion of a human ear with an ear piece communication device inserted therein according to an exemplary embodiment.

FIGS. 3 and 4 are cross-sectional views of a portion of an ear piece communication device according to an exemplary embodiment.

FIG. 5 is a block diagram of electronic components of an ear piece communication device according to an exemplary embodiment.

### DETAILED DESCRIPTION

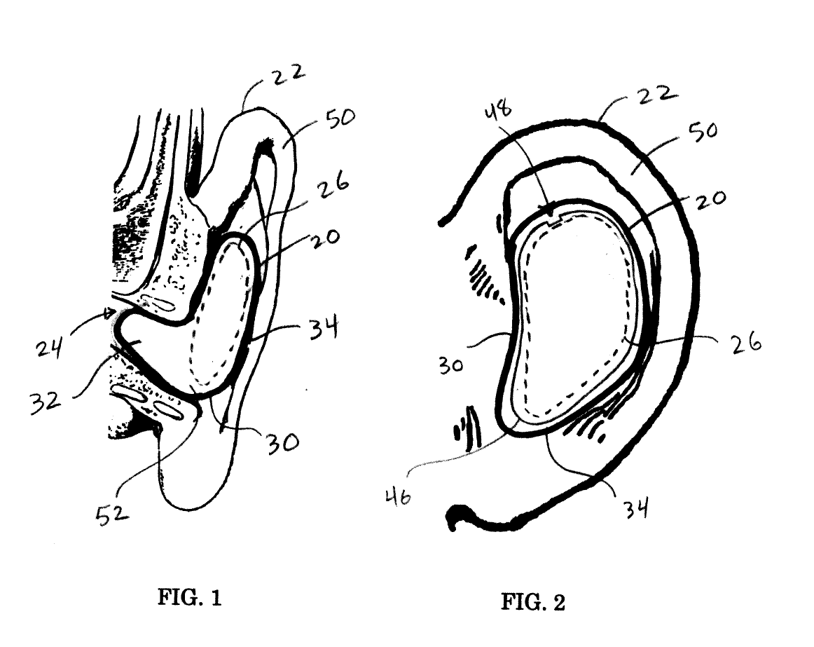

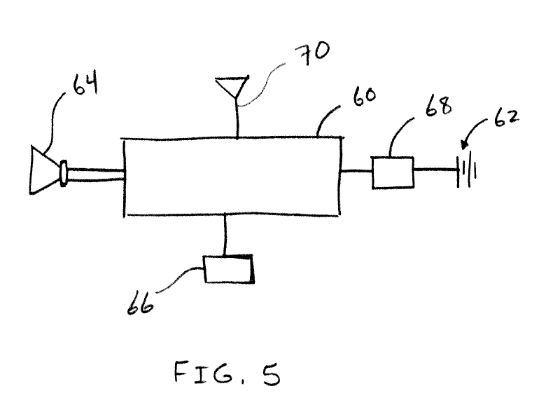

Referring to FIGS. 1 and 2, an ear piece communication device 20 according to an embodiment is shown inserted in an ear 22 of a user of the communication device 20. The communication device 20 fits at least partly inside a portion of the user's ear canal 24. The communication device 20 allows the user to receive broadcast radio signals or radio signals on one or more particular frequencies. In one embodiment, the communication device 20 includes an external surface area 26 for displaying visual information such as text and/or graphics. The communication device includes a body 30 having a first portion 32 which is at least partly shaped or can be shaped by a user to fit inside a portion of the user's ear canal 24, and a second portion 34, which may be generally positioned outside the user's ear canal 24. The first portion 32 includes an aperture or hollow cylindrical portion 33 shown in FIG. 4) for allowing the sound generated inside the body 30 to reach the user's ear drum through the ear canal 24.

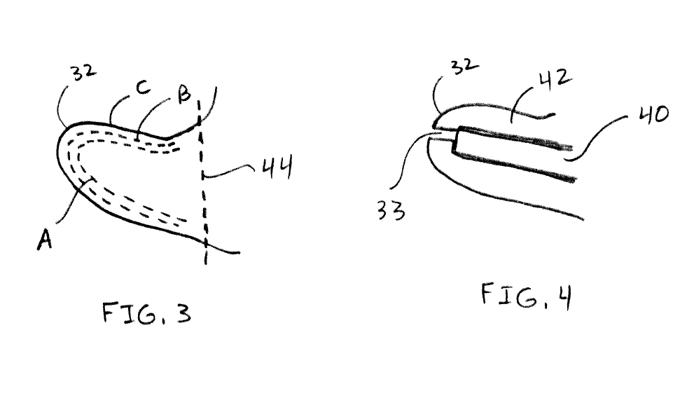

In one embodiment shown in FIG. 3, the first portion 32 may be provided in different sizes as shown by the dashed lines in FIG. 3 to accommodate different users of the communication device 20. For example, the first portion 32 may be provided in a small size A, a medium size B, or a large size C in order to provide a generally comfortable fitting for children, young adults, and adults, respectively.

The first portion 32 may be constructed from rigid or semi-rigid materials and generally shaped to fit at least partly inside the ear canals of most users. Alternatively, the first portion 32 may be constructed from pliable materials such as silicone, rubber, foam, memory foam or other plastic materials so as to be flexible and pliable. Furthermore, the first portion 32 may be constructed from a material that is elastically pliable or flexible. Accordingly, a user can squeeze the first portion 32 for insertion into his or her ear canal. After the first portion 32 is at least partly placed in a portion of the user's ear canal 24, the first portion 32 expands to engage the inner walls of the ear canal and maintain the communication device 20 connected to the user's ear.

In one embodiment shown in FIG. 4, the first portion 32 includes a tubular core 40, which may be constructed from plastics, metal, or the like. The first portion 32 also includes a flexible, pliable and/or elastic shell 42 constructed from silicone, rubber, foam, memory foam or other plastic materials that can be inserted over the core 40. The communication device 20 can be provided with several elastic shells 42 of similar and/or different sizes to allow a user to change the elastic shell 42 to provide a better fit or for hygienic reasons.

In another embodiment also shown in FIG. 3, the first portion 32 may be removable from the second portion 34 along the dotted line 44 or at another section of the body 30 in order to allow the user to change the first portion 32 when preferred or necessary. For example, the first portion 32 may be replaced with another first portion 32 for hygienic reasons or to change the size of the first portion 32.

Referring to FIGS. 1 and 2, the second portion 34 is positioned outside the user's ear canal 24, yet it remains at least partly within the user's outer ear 50 (i.e., scientifically referred to as Auricula or Pinna). The second portion 34 may engage a portion of the outer ear 50 to maintain the communication device 20 connected to the user's ear 22. The communication device 20 may also include a connection portion 52 between the first portion 32 and the second portion 34 that connects the first portion 24 to the second portion 28 and may engage a portion of the outer ear 50 to maintain the communication device 20 connected to the user's ear. Thus, engagement of the first portion 32 with the ear canal 24, engagement of the connecting portion 52 with the outer ear 50, and/or engagement of the second portion 34 with the outer ear 50 maintain the communication device 20 connected to the user's ear.

Referring to FIG. 2, the second portion 34 is larger than the first portion 32 and includes the external surface area 26 which is generally flat (i.e., flat, slightly curved, etc.) so as to provide a display space for a variety of visually related purposes, such as advertisements, product or service promotions and/or information signifying an event, etc. For example, the external surface area 26 may include stylized text to promote a sports team. In order to allow the display to be changed when preferred, the second portion 34 may be removable from the first portion 32 and/or removable from the connection portion 52. Alternatively, the external surface area 26 may be part of a cap 46, lid or the like (shown in FIG. 2), such that it can be removable from the body 30. Accordingly, the visual contents of the external surface area 26 can be changed by as preferred by changing the cap 46. The cap 46 may be changed by lifting the cap 46 with a tab 48. The external surface area 26 may be in any shape, such as circular, oval, rectangular, etc. Furthermore, the largest dimension (i.e., diameter, diagonal, etc.) of the external surface area 26 may be under 1 inch or greater than one inch, such as between 1 and 2 inches

The communication device includes electronically operated components inside the body 30 for receiving radio signals, converting the radio signals to audio signals, and producing sound from the audio signals in the user's ear canal 24. Referring to FIG. 5, the electronic components include a radio or receiver 60, a battery 62 for powering the receiver 60 and a speaker 64 for producing sound from audio signals generated by the radio 60. The electronic components may also include a sound level control or volume control 66 and an on/off switch 68, both of which be mounted on the body 30 and are accessible by the user for making adjustments. The communication device 20 may also include an antenna 70 for assisting the radio 60 with receiving radio signals. The receiver 60, the antenna 70 and the battery 62 may be positioned either in the first portion 32 or the second portion 34. However, because the second portion 34 may have more internal space than the first portion 32, these components may be located in the second portion 34. Accordingly, the first portion 32 may include only the speaker 64 so as to provide audio to the user's ear canal. FIG. 5 is an exemplary diagram of the electronic components of the communication device 20. Circuit diagrams of the radio 60, the battery 62, the speaker 64, the volume control 66, the on/off switch 68, and the antenna 70 are not shown in FIG. 5 as the details of these components are well known to those of ordinary skill in the art.

The radio 60 may be an FM radio and/or an AM radio capable of tuning into different broadcast frequencies. The radio 60 may be a single channel FM or AM radio. The circuit diagram and further details of such a single channel FM or AM radio is not provided herein since such radios are well known to those of ordinary skill in the art. The communication device 20 is not limited to a single channel FM or AM radio and may include any type of receiver capable of receiving transmissions broadcast on a single or a range of different frequencies. Accordingly, the communication device 20 may include tuning control (not shown) in the form of a dial, projection, screw or the like on or inside the body 30 to allow a user, vendor or the manufacturer of the communication device 20 to tune the radio 60 to a preferred frequency.

In one embodiment, the communication device 20 is a single frequency radio that is disposable after the battery 62 is depleted. Accordingly, the above described components of the body 30 may be fastened, bonded, snap fitted, or sealed such that the internal space of the body 30 is inaccessible to the user. For example, the body 30 may be manufactured from a rigid or semi-rigid plastic material in one or more pieces that are bonded together so as to appear to have been formed as a one-piece body.

In one embodiment, the communication device 20 may be used in concerts, sporting events or other large gatherings in a defined space. For example, the operator of an arena hosting a sporting event or a broadcaster of the sporting event may have the communication device 20 available for purchase. A spectator who purchases the communication device 20 can then place the communication device 20 on his or her ear as described above. Audio programs can then be broadcast during the sporting event on a single frequency of the communication devices 20. For example, the broadcaster can broadcast live play-by-play analysis and comments on the single frequency of the communication device 20. The spectators can then enjoy watching the sporting event while listening to the live play-by-play analysis and comments. Furthermore, during time-outs, intermissions, breaks, etc. the broadcaster can advertise various products and/or services to the spectators through the communication device 20.

The battery 62 may be designed so as to power the radio 60 for at least the entire duration of the sporting event. In order to provide safeguards against early battery depletion, however, the battery 62 may be designed to generally or on average last minutes or hours longer than the typical duration of the sporting event. Accordingly, the battery 62 can be made small, light weight, and relatively less costly than longer lasting batteries. Upon conclusion or end of the sporting event, the spectator can either discard the communication device 20 or keep it as a souvenir.

The battery 70 may be a multiuse, relatively long lasting, or rechargeable. Accordingly, the battery 62 may be configured so as to be capable of lasting much longer than described above in order to be reusable for another sporting event. The area hosting the sporting event or the team itself can have available for sale a number of different communication devices 20 that have different battery lives. A potential purchaser of the communication device 20 can then choose which communication device 20 to purchase based on cost and whether or not the spectator will be attending other similar sporting events during which the communication device 20 can be used.

The second portion 34 may be include a hollow space so as to house all or some of the electronic components described above. Due to the second portion 34 providing a large surface area as compared to the rest of the communication device 20, the second portion 34 may provide a suitable space for the antenna 70. The external surface area 26 allows a seller or manufacturer of the communication device 20 to display visual information such as text and/or graphics for advertising and/or promotional purposes. For example, the external surface area 26 can display the logo or the name of a sporting team, a product and/or a service. During a sporting event, the external surface area 26 can include the home team's logo. The seller of the communication device 20, which may be the owner or the operator of the sporting arena or the home team, can promote various products on the external surface area 26 to generate additional revenue, which may offset the cost of procuring the communication device 20. For example, the communication device 20 can display visual information depicting a certain food or beverage for purchase. In another example, the display space on the external surface area 26 can be licensed to an advertiser on a per game, per season, or longer term basis. The operator of the sporting arena, the home or the away team, or other associated parties can then generate one time, periodic or long term revenue from the licensing of the display space on the external surface area 26.

The body 30 may be constructed from rigid or semi-rigid plastic materials. Furthermore, the body 30 may be constructed having a preferred color. For example, when the communication device 20 is used at a sporting event, the body 30 may be constructed from one or more colors that represent the sporting team's colors (e.g. blue and yellow).

The body 30 may be constructed so that the first portion 32, the connecting portion 52, and the second portion 34 are inseparable by hand or with typical tools. Accordingly, such a communication device 20 may be suited for one-time or short-term use. The body 30 may also be constructed so that the first portion 32, the connection portion 52, the second portion 34, and/or the electronic components inside the body 30 are all removable by the manufacturer, vendor and/or the user. Accordingly, the communication device 20 can be repaired and/or modified. For example, a defective battery in such a communication device 20 can be replaced with another battery. In another example, the cap 46 can be removed and replaced with another cap 46 by the seller or the user of the communication device 20 in order to change the visual information on the external surface area 26. For example, the user of the communication device 20 can be provided with multiple caps 46 upon purchasing the communication device 20 so as to be able to change the cap 46 as preferred. Furthermore, the buyer of the communication device 20 can be provided with self-adhesive stickers which include visual information for attachment to the external surface area 26. Thus, the user of the communication device 20 can choose one or more stickers to attach to the external surface area 26.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A communication device comprising:
a body having a first portion configured to fit at least partly inside a portion of a user's ear canal, and a second portion connected to the first portion and configured to be positioned at least partly within an outer ear of the user; and
a radio assembly at least partly housed in the body and comprising:
a receiver configured to receive radio signals;
a battery configured to power the receiver; and
a speaker connected to the radio and configured to provide audio signals to the user through the first portion.

2. The communication device of claim 1, wherein the second portion comprises an external surface area outwardly facing relative to the outer ear of the user, the external surface area configured to display visual information.

3. The communication device of claim 1, wherein a section of the second portion including the external surface area is removable from the second portion.

4. The communication device of claim 2, wherein a largest dimension of the external surface area is at least 1 inch.

5. The communication device of claim 2, wherein a largest dimension of the external surface area is at least between 1 inch and 2 inches.

6. The communication device of claim 2, wherein the visual information is provided on a sheet-like material which is attached to the external surface area.

7. The communication device of claim 1, wherein the battery is configured to power the radio receiver for less than 5 hours.

8. The communication device of claim 1, wherein the battery is a rechargeable battery.

9. The communication device of claim 1, wherein the battery is removable from the body and replaceable with another battery.

10. The communication device of claim 1, further comprising a volume dial and an ON/OFF switch mounted on the body and operatively coupled to the radio receiver.

11. The communication device of claim 1, wherein the first portion is removable from the body.

12. The communication device of claim 11, comprising a plurality of first portions configured to be interchangeably connectable to the body.

13. The communication device of claim 1, wherein the first portion is at least partly constructed from an elastically pliable material such that the first portion is configured to be shaped by a user to fit in the user's ear canal.
